(19) United States
(12) Patent Application Publication
(10) Pub. No.: US 2024/0013666 A1
(43) Pub. Date: Jan. 11, 2024

(54) TINNITUS DIGITAL THERAPY METHOD AND APPARATUS WITH COGNITIVE BEHAVIOR THERAPY AND TINNITUS RETRAINING THERAPY

(71) Applicant: OLIVE UNION, INC., Seoul (KR)

(72) Inventors: Myunggeun SONG, Seoul (KR); Taeho SON, Seoul (KR); Jiwon CHOI, Seoul (KR)

(21) Appl. No.: 17/938,495

(22) Filed: Oct. 6, 2022

(30) Foreign Application Priority Data
Jul. 11, 2022 (KR) 10-2022-0084877

(51) Int. Cl. G09B 5/04; G09B 7/02; G09B 23/28

(52) U.S. Cl. CPC G09B 5/04; G09B 7/02; G09B 23/28

(57) ABSTRACT

Disclosed are a tinnitus digital therapy method and apparatus involving cognitive behavior therapy and tinnitus retraining therapy. According to an embodiment, a tinnitus digital therapy method involving cognitive behavior therapy and tinnitus retraining therapy, which are performed by a computer device, includes performing tinnitus retraining therapy (TRT) corresponding to a tinnitus frequency of a user, and performing cognitive behavior therapy (CBT) such that the user is to recognize tinnitus to change from a negative reaction to a positive reaction.

### CROSS-REFERENCE TO RELATED APPLICATIONS

A claim for priority under 35 U.S.C. § 119 is made to Korean Patent Application No. 10-2022-0084877 filed on Jul. 11, 2022, in the Korean Intellectual Property Office, the entire contents of which are hereby incorporated by reference.

### BACKGROUND

Embodiments of the inventive concept described herein relate to a tinnitus digital therapy method and apparatus with cognitive behavior therapy and tinnitus retraining therapy for improving awareness of tinnitus and alleviating tinnitus, and more specifically, a tinnitus digital therapy method and apparatus with cognitive behavior therapy and tinnitus retraining therapy using built-in software (smartphone application or the like) with digital treatment for tinnitus and earphones and hearing aids that deliver sound.

Tinnitus is a kind of hearing-related disease in which noise is heard in ears without external sound stimulation. It is also known that half of patients with tinnitus are accompanied by depression. In Korea, it is reported that about 15% of the total population experience tinnitus, and about 8% have the severity of sleep disturbance and about 1% experience the disorder that prohibits people from living normal lives. In particular, with the development of industry, the number of tinnitus patients is gradually increasing due to an increase in noise, an increasingly complex mental life, an increase in the elderly population, and drug abuse, or the like. Therefore, the importance of diagnosis and treatment of tinnitus patients is rising.

The mechanism of occurrence of tinnitus is not clearly defined, but there are mechanisms including a pathological mechanism for hearing loss/brain and a mechanism in which hearing loss affects perception and emotions in the brain while passing through the limbic system.

Although the number of patients with tinnitus is increasing for reasons such as stress, there is still no clear drug treatment method for tinnitus. Sound therapy software such as tinnitus masking has also appeared one after another, but its effectiveness is still insignificant. Therefore, cognitive behavior therapy with sound therapy is needed to improve tinnitus awareness and alleviate tinnitus.

Korean Patent Registration No. 10-1745027 relates to such a customized tinnitus therapy device and a method for stimulating auditory cells in tinnitu s patients, and describes a technology for a device for treating tinnitus using a sound signal.

### SUMMARY

Embodiments of the inventive concept provide a tinnitus digital therapy method and apparatus with cognitive behavior therapy and tinnitus retraining therapy and more specifically, provide a tinnitus digital therapy method and apparatus with cognitive behavior therapy and tinnitus retraining therapy using built-in software (smartphone application or the like) with digital treatment for tinnitus and earphones and hearing aids that deliver sound.

Embodiments of the inventive concept provide a tinnitus digital therapy apparatus and method and device with Cognitive Behavior Therapy (CBT) and Tinnitus Retraining Therapy (TRT), which can alleviate tinnitus and improve tinnitus awareness by changing the user's perception for tinnitus by using two of cognitive behavior therapy (CBT) and tinnitus retraining therapy (TRT) in combination.

According to an exemplary embodiment, a tinnitus digital therapy method involving cognitive behavior therapy and tinnitus retraining therapy, which is performed by a computer device, includes performing tinnitus retraining therapy (TRT) corresponding to a tinnitus frequency of a user, and performing cognitive behavior therapy (CBT) such that the user is to recognize tinnitus to change from a negative reaction to a positive reaction.

The performing of the tinnitus retraining therapy (TRT) may include identifying the user's preference for a positive sound stimulus through a question provided by an application installed in a terminal and an answer, and checking the tinnitus frequency of the user and a volume through the question provided by the application and the answer.

The checking of the tinnitus frequency of the user and the volume may include determining the tinnitus frequency through a tinnitus test through the question provided by the application installed in the terminal and the answer, and identifying a frequency and an intensity of a tone or noise closest to the tinnitus that the user feels most uncomfortable through the tinnitus test to perform matching of a closest frequency and a closest volume.

The checking of the tinnitus frequency of the user and the volume may include performing a test while changing the volume of a stimulus sound using a pure tone or noise to find out the volume of the tinnitus, and checking the volume of the tinnitus by adjusting the stimulus sound while determining whether the tinnitus is larger or smaller than a matched test sound, when the tinnitus frequency is identified.

The performing of the tinnitus retraining therapy (TRT) may include modulating a sound source for tinnitus treatment according to the tinnitus frequency of the user, and positively restructuring a situation or event in which the tinnitus occurs.

The modulating of the sound source may include identifying the tinnitus frequency of the user and applying a filter to perform the tinnitus treatment using notch therapy that removes a predetermined band included in the tinnitus frequency.

The performing of the tinnitus retraining therapy (TRT) may further include performing training to identify an automatic thought for the tinnitus, planning and evaluating the automatic thought for the tinnitus, and performing training to record the automatic thought for the tinnitus, to identify preference for positive sound stimuli by planning and evaluating the automatic thought for the tinnitus.

The performing of the cognitive behavior therapy (CBT) may further include reinforcing behavioral beliefs for the tinnitus, practicing behavior repetition for the tinnitus, and evaluating an emotional reaction for the tinnitus, to perform training to identify an automatic thought for the tinnitus through evaluation of the emotional reaction.

According to an exemplary embodiment, a tinnitus digital therapy apparatus involving cognitive behavior therapy and tinnitus retraining therapy may include a tinnitus retraining therapy unit that performs tinnitus retraining therapy (TRT) corresponding to a tinnitus frequency of a user, and a cognitive behavior therapy unit that performs cognitive behavior therapy (CBT) such that the user is to recognize tinnitus to change from a negative reaction to a positive reaction.

The tinnitus retraining therapy unit may include a sound stimulation preference identification unit that identifies the user's preference for a positive sound stimulus through a question provided by an application installed in a terminal and an answer, and a tinnitus frequency and volume checking unit that checks the tinnitus frequency of the user and a volume through the question provided by the application and the answer.

The tinnitus frequency and volume checking unit may determine the tinnitus frequency through a tinnitus test through the question provided by the application installed in the terminal and the answer, and identify a frequency and an intensity of a tone or noise closest to the tinnitus that the user feels most uncomfortable through the tinnitus test to perform matching of a closest frequency and a closest volume.

The tinnitus frequency and volume checking unit may perform a test while changing the volume of a stimulus sound using a pure tone or noise to find out the volume of the tinnitus, and check the volume of the tinnitus by adjusting the stimulus sound while determining whether the tinnitus is larger or smaller than a matched test sound, when the tinnitus frequency is identified.

The tinnitus retraining therapy unit may include a sound source modulator that modulates a sound source for tinnitus treatment according to the tinnitus frequency of the user, and a positive restructuring unit that positively restructures a situation or event in which the tinnitus occurs.

The tinnitus retraining therapy unit may include an automatic thought identification unit that performs training to identify an automatic thought for the tinnitus, an automatic thought evaluation unit that plans and evaluates the automatic thought for the tinnitus, and an automatic thought record training unit that performs training to record the automatic thought for the tinnitus to identify preference for positive sound stimuli by planning and evaluating the automatic thought for the tinnitus.

The cognitive behavior therapy unit may include a behavioral belief reinforcement unit that reinforces behavioral beliefs for the tinnitus, a behavior repetition practice unit that practices behavior repetition for the tinnitus, and an emotional reaction evaluation unit that evaluates an emotional reaction for the tinnitus to perform training to identify an automatic thought for tinnitus through evaluation of the emotional reaction.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram for describing the concept of a tinnitus digital therapy method with Cognitive Behavior Therapy (CBT) and Tinnitus Retraining Therapy (TRT) according to an embodiment;

FIG. 2 is a flowchart for describing a tinnitus digital therapy method involving cognitive behavior therapy and tinnitus retraining therapy according to an embodiment;

FIG. 3 is a diagram for describing a digital therapy apparatus for tinnitus with Cognitive Behavior Therapy (CBT) and Tinnitus Retraining Therapy (TRT) according to an embodiment;

FIG. 4 is s a block diagram illustrating a tinnitus digital therapy apparatus involving cognitive behavior therapy and tinnitus retraining therapy according to an embodiment;

FIG. 5 is a view for describing an example of tinnitus treatment using notch therapy according to an embodiment;

FIG. 6 is a view for describing another example of tinnitus treatment using notch therapy according to an embodiment;

FIGS. 7A to 7C are diagrams illustrating an example of a tinnitus digital therapy apparatus involving cognitive behavior therapy and tinnitus retraining therapy provided through an application according to an embodiment.

FIGS. 8A to 8D are diagrams illustrating an example of a tinnitus test according to an embodiment.

### DETAILED DESCRIPTION

Hereinafter, embodiments will be described with reference to the accompanying drawings. However, embodiments to be described may be modified in various other ways, and the scope of the inventive concept is not limited by the embodiments to be described below. In addition, various embodiments are provided to more completely describe the inventive concept to those of ordinary skill in the art. Shapes, sizes, and the like of elements in the drawings may be exaggerated for clearer description.

The following embodiments provide a tinnitus digital therapy method and apparatus with cognitive behavior therapy (CBT) and tinnitus retraining therapy (TRT) for improving awareness of tinnitus and alleviating tinnitus.

The embodiments disclose a method of using cognitive behavior therapy (CBT) and tinnitus retraining therapy (TRT) in combination. The principle of cognitive behavior therapy (CBT)-based tinnitus digital therapy is to change users' awareness of tinnitus. In addition, tinnitus retraining therapy (TRT)-based digital therapy for tinnitus is a method of tinnitus relief and awareness improvement.

According to embodiments, the user's cognition may be improved through Cognitive Behavior Therapy (CBT) and tinnitus retraining therapy (TRT). More specifically, according to embodiments, cognitive reconstruction may be achieved from reaction that tinnitus is negative such as pain to reaction that tinnitus is positive such as pleasure, through cognitive behavior therapy (CBT) and tinnitus retraining therapy (TRT). In other words, there may be a change from a negative reaction such as “tinnitus=pain” to a positive reaction such as “tinnitus=pleasure”.

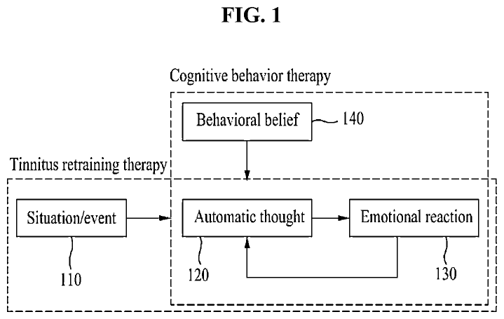

FIG. 1 is a diagram for describing the concept of a tinnitus digital therapy method with Cognitive Behavior Therapy (CBT) and Tinnitus Retraining Therapy (TRT) according to an embodiment.

Referring to FIG. 1, tinnitus retraining therapy (TRT) is a therapy to train brains not to recognize specified sound although the specified sound is continuously heard or not to be painful although the specified sound is recognized, when it is trained that the specified sound is unimportant. When the specified sound is classified as an unimportant sound, the brain filters the signal at the subconscious level to cause the signal to be no longer connected to the limbic system and the autonomic nervous system.

The tinnitus retraining therapy (TRT) is a therapy to repeatedly reduce the intensity of tinnitus by using sounds (such as white noise) to reduce the response of the limbic system and the autonomic nervous system, which allows the limbic system and the autonomic nervous system to recognize tinnitus signals as insignificant signals. By understanding tinnitus, changing perceptions of tinnitus, and associating tinnitus with positive emotions, it is possible to reduce the level of stress caused by tinnitus.

Here, tinnitus retraining therapy (TRT) may perform treatment so as to make the emotional reaction 130 of automatic thought 120 for a situation/event 110 positive from negative.

In addition, cognitive behavior therapy (CBT) is a type of psychological treatment to treat maladaptive behavior by systematically integrating concepts, principles, and theories related to the aspects of psychomotor behavior that are concretely expressed at the same time as cognitive aspects such as thoughts, beliefs, and values. In general, it is a broad concept that refers to the attempts of counseling and psychotherapy to integrate behavior modification based on conditioning theory and cognitive therapy with the cognitive approach of Kelly and Ellis.

Here, cognitive behavior therapy (CBT) can treat the emotional reaction 130 of the automatic thought 120 to the behavioral belief 140 from a negative part to a positive part.

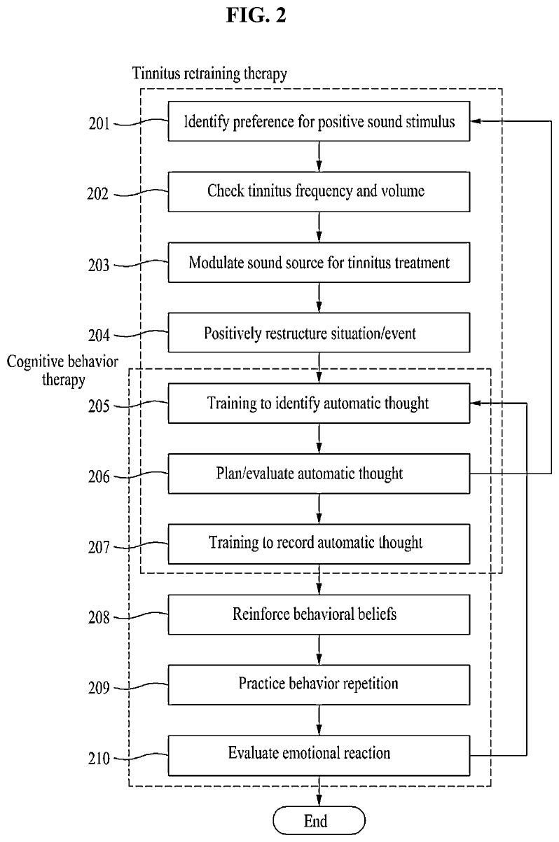

FIG. 2 is a flowchart for describing a tinnitus digital therapy method involving cognitive behavior therapy and tinnitus retraining therapy according to an embodiment.

Referring to FIG. 2, in the digital treatment method of tinnitus involving cognitive behavior therapy and tinnitus retraining therapy according to the embodiment, a user repeatedly interacts with a software program through sound stimulation. According to embodiments, it is possible to make tinnitus to be recognized as a pleasant sound, and recognized as a part of daily life.

According to an embodiment, a tinnitus digital therapy method involving cognitive behavior therapy and tinnitus retraining therapy, which is performed by a computer device, includes performing tinnitus retraining therapy (TRT) corresponding to a tinnitus frequency of a user, and performing cognitive behavior therapy (CBT) such that the user is to recognize tinnitus to change from a negative reaction to a positive reaction.

Specifically, the tinnitus digital therapy method involving cognitive behavior therapy and tinnitus retraining therapy, which is performed by a computer device, may include identifying the user's preference for a positive sound stimulus through a question provided by an application installed in a terminal and an answer (201) and checking a tinnitus frequency of the user and a volume through a question provided by the application and an answer (202).

Further, the tinnitus digital therapy method may include modulating a sound source for tinnitus treatment according to the tinnitus frequency of the user (203), and positively restructuring a situation or event in which tinnitus occurs (204). They may be included in the performing of the tinnitus retraining therapy (TRT).

Further, the tinnitus digital therapy method may include performing training to identify an automatic thought for tinnitus (205), planning and evaluating the automatic thought for tinnitus (206), and performing training to record the automatic thought for tinnitus (207) to identify preference for positive sound stimuli by planning and evaluating the automatic thought for tinnitus. They may be included in the performing of the tinnitus retraining therapy (TRT) and the performing of the cognitive behavior therapy (CBT).

Further, the tinnitus digital therapy method may include reinforcing behavioral beliefs for tinnitus (208), practicing behavior repetition for the tinnitus (209), and evaluating an emotional reaction for the tinnitus (210), to perform training to identify an automatic thought for tinnitus through evaluation of the emotional reaction. They may be included in the performing of the cognitive behavior therapy (CBT).

Hereinafter, a tinnitus digital therapy method with cognitive behavior therapy and tinnitus retraining therapy according to an embodiment will be described in more detail.

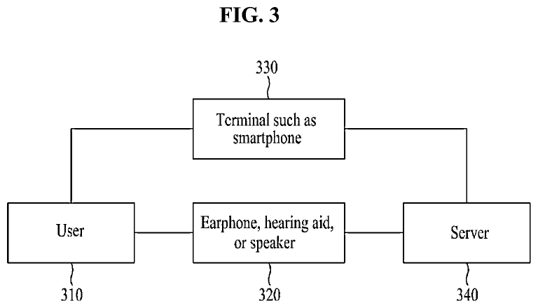

FIG. 3 is a diagram for describing a digital therapy apparatus for tinnitus with Cognitive Behavior Therapy (CBT) and Tinnitus Retraining Therapy (TRT) according to an embodiment.

Referring to FIG. 3, a tinnitus digital therapy apparatus with cognitive behavior therapy and tinnitus retraining therapy according to an embodiment may be mounted on a user terminal 320 such as a smartphone in the form of an application and may interwork with a sound device 330 such as earphones, hearing aids, and speakers that a user 310 possesses, and also with a server 340.

In particular, the tinnitus digital therapy apparatus with cognitive behavior therapy and tinnitus retraining therapy according to an embodiment may utilize a digital therapeutic agent in conjunction with a hearing aid tailored to an individual's hearing or a personalized acoustic device.

In the server 340, an external expert or professional doctor may monitor the user's condition and progress, and remote treatment and feedback may be delivered through video chatting or the like. In this case, the external expert or professional doctor may directly set and modify the cognitive behavior therapy (CBT) and tinnitus retraining therapy (TRT) programs.

The tinnitus digital therapy method with cognitive behavior therapy and tinnitus retraining therapy according to an embodiment may be described using the tinnitus digital therapy apparatus with cognitive behavior therapy and tinnitus retraining therapy according to an embodiment as an example.

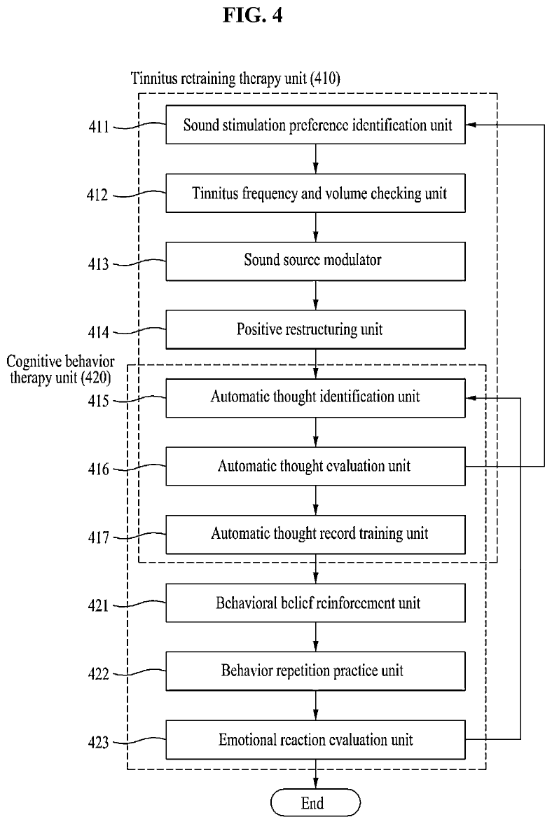

FIG. 4 is s a block diagram illustrating a tinnitus digital therapy apparatus involving cognitive behavior therapy and tinnitus retraining therapy according to an embodiment.

Referring to FIG. 4, a tinnitus digital therapy apparatus 400 involving cognitive behavior therapy and tinnitus retraining therapy according to an embodiment may include a tinnitus retraining therapy unit 410 and a cognitive behavior therapy unit 420. Here, the tinnitus retraining therapy unit 410 may include a sound stimulation preference identification unit 411, a tinnitus frequency and volume checking unit 412, a sound source modulator 413, a positive restructuring unit 414, an automatic thought identification unit 415, an automatic thought evaluation unit 416 and an automatic thought record training unit 417. The cognitive behavior therapy unit 420 may include a behavioral belief reinforcement unit 421, a behavior repetition practice unit 422, and an emotional reaction evaluation unit 423.

First, the tinnitus retraining therapy unit 410 may perform tinnitus retraining therapy (TRT) corresponding to a user's tinnitus frequency.

In step 201, the sound stimulation preference identification unit 411 may identify the user's preference for a positive sound stimulus through a question and answer provided by an application installed in a terminal.

In step 202, the tinnitus frequency and volume checking unit 412 may check a tinnitus frequency and a volume of the user through a question and answer provided by the application. In other words, it is possible to provide a service for checking the volume and frequency of tinnitus by performing a tinnitus test in software.

More specifically, the tinnitus frequency and volume checking unit 412 may determine the tinnitus frequency through a tinnitus test through a question and answer provided by an application installed in the terminal. For example, subjective discomfort caused by tinnitus may be scored and measured using a questionnaire (tinnitus discomfort scale) provided by the software.

Here, tinnitus can be broadly defined as five types of sounds. The five types of sounds may include buzzing, roaring, clicking, hissing, and humming.

First, the tinnitus frequency and volume checking unit 412 may identify the frequency and intensity of a tone or noise closest to the tinnitus that the user feels most uncomfortable through the tinnitus test to perform matching of the closest frequency and volume. Then, when the tinnitus frequency is identified, the tinnitus frequency and volume checking unit 412 may perform a test while changing the volume of a stimulus sound using a pure tone or noise in order to find out the volume of the tinnitus, and check the volume of the tinnitus by adjusting the stimulus sound with a stimulus sound while determining whether the tinnitus is larger or smaller than a matched test sound.

In step 203, the sound source modulator 413 may modulate the sound source for tinnitus treatment according to the user's tinnitus frequency.

In this case, tinnitus treatment using Notch Therapy may be performed. More specifically, the sound source modulator 413 may identify the user's tinnitus frequency and apply a filter to perform tinnitus treatment using notch therapy that removes a predetermined band included in the tinnitus frequency. Accordingly, it is possible to reduce the detail effect of tinnitus and provide emotional stability.

In step 204, the positive restructuring unit 414 may positively restructure a situation or event in which tinnitus occurs.

In step 205, the automatic thought identification unit 415 may be trained to identify automatic thoughts for tinnitus.

In step 206, the automatic thought evaluation unit 416 may plan and evaluate an automatic thought for tinnitus. Here, it is possible to identify preference for positive sound stimuli by planning and evaluating the automatic thought for tinnitus.

In step 207, the automatic thought record training unit 417 may be trained to record automatic thoughts for tinnitus.

Meanwhile, according to an embodiment, steps 205, 206, and 207 may be included in the cognitive behavior therapy unit 420. That is, the automatic thought identification unit 415 of the cognitive behavior therapy unit 420 may be trained to identify an automatic thought for tinnitus, and the automatic thought evaluation unit 416 may plan and evaluate the automatic thought for tinnitus. In addition, the automatic thought record training unit 417 may be trained to record automatic thoughts for tinnitus.

The cognitive behavior therapy unit 420 may perform cognitive behavior therapy (CBT) such that the user is to recognize the tinnitus to change from a negative reaction to a positive reaction.

In step 208, the behavioral belief reinforcement unit 421 may reinforce behavioral beliefs for tinnitus.

In step 209, the behavior repetition practice unit 422 may practice behavior repetition for tinnitus.

In step 210, the emotional reaction evaluation unit 423 may evaluate an emotional reaction to tinnitus. Here, through emotional reaction evaluation, it is possible to perform training to identify an automatic thought for tinnitus.

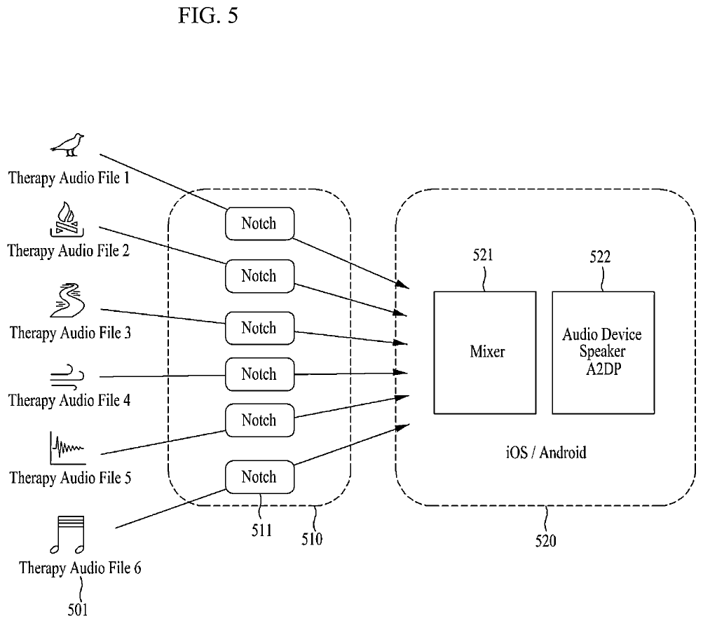

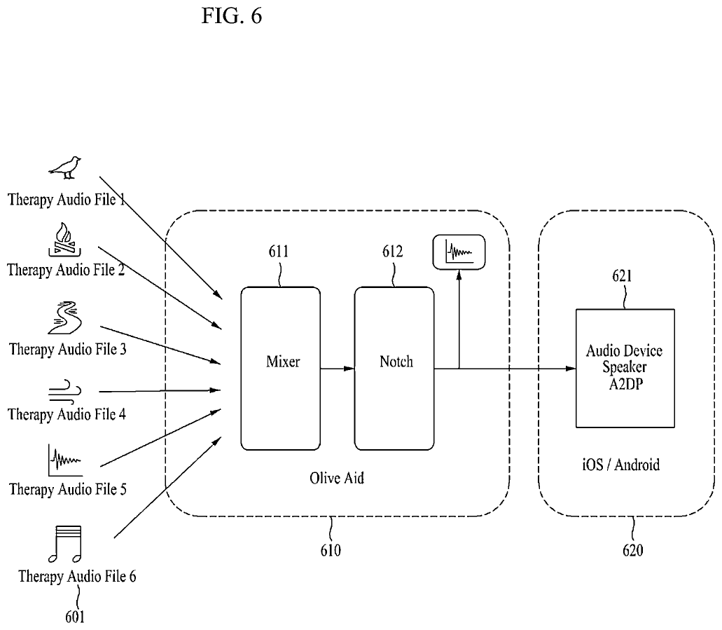

FIG. 5 is a view for describing an example of tinnitus treatment using notch therapy according to an embodiment, and FIG. 6 is a view for describing another example of tinnitus treatment using notch therapy according to an embodiment.

Referring to FIG. 5, a tinnitus digital therapy apparatus 510 involving cognitive behavior therapy and tinnitus retraining therapy according to an embodiment may receive various therapeutic sound sources 501 and transmit the therapeutic sound sources 501 to a user terminal 520. For example, the various therapeutic sound sources 501 may include a bird sound, a bonfire burning sound, a sound from a road or a specific place, a wind sound, a rain sound, a specific sound source, specific music, and the like. In this case, the tinnitus digital therapy apparatus 510 involving cognitive behavior therapy and tinnitus retraining therapy according to an embodiment may remove a specific frequency of the therapeutic sound source 501 to which a notch filter 511 has been applied and input, and a noise included in the specific frequency. Thereafter, the tinnitus treatment may be performed by providing a sound source through a mixer 521 of the terminal 520 and a speaker 522 of an audio device.

Referring to FIG. 6, a tinnitus digital therapy apparatus 610 involving cognitive behavior therapy and tinnitus retraining therapy according to an embodiment may receive various therapeutic sound sources 601 and transmit the therapeutic sound sources 601 to a user terminal 620. In this case, the tinnitus digital therapy apparatus 610 involving cognitive behavior therapy and tinnitus retraining therapy according to an embodiment may mix the various therapeutic sound sources 601 through a mixer 611 and remove a specific frequency of the therapeutic sound source 601 to which a notch filter 612 has been applied and input, and a noise included in the specific frequency. Thereafter, the tinnitus treatment may be performed by providing a sound source through a speaker 621 of an audio device of the terminal 620.

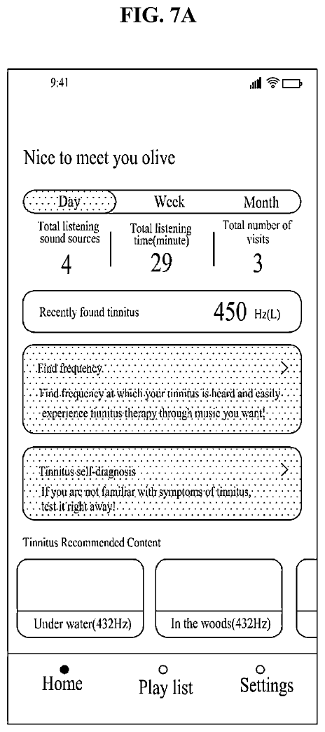

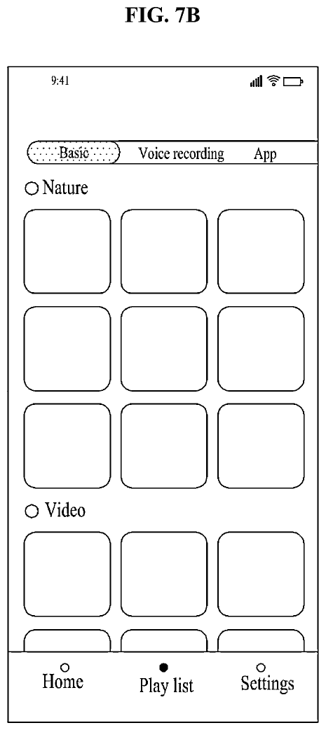

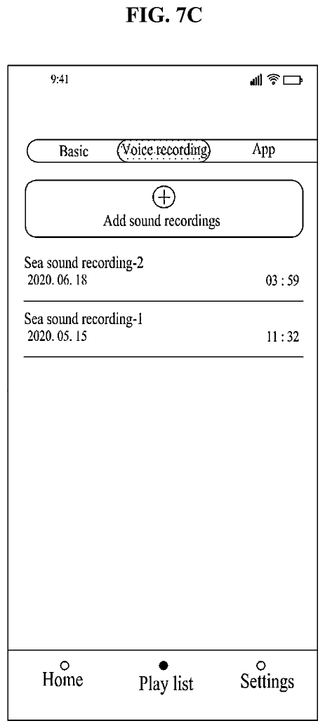

FIGS. 7A to 7C are diagrams illustrating an example of a tinnitus digital therapy apparatus involving cognitive behavior therapy and tinnitus retraining therapy provided through an application according to an embodiment.

Referring to FIG. 7A, a tinnitus digital therapy apparatus involving cognitive behavior therapy and tinnitus retraining therapy according to an embodiment may identify a tinnitus frequency for each user through membership registration and log-in, and provide a therapeutic sound source according to the tinnitus frequency. In this case, information about the user may be additionally recorded. In addition, a method for finding out a user's tinnitus frequency may be provided through an application.

As shown in FIG. 7B, the tinnitus digital therapy apparatus involving cognitive behavior therapy and tinnitus retraining therapy according to an embodiment may provide a sound source for tinnitus treatment, such as a sound of nature, a meditation sound source through an application.

In addition, as shown in FIG. 7C, the tinnitus digital therapy apparatus involving cognitive behavior therapy and tinnitus retraining therapy according to an embodiment may provide sound recordings, recorded by an administrator or user through an application, for tinnitus treatment. In addition, the user may download and use an additional sound source through the application.

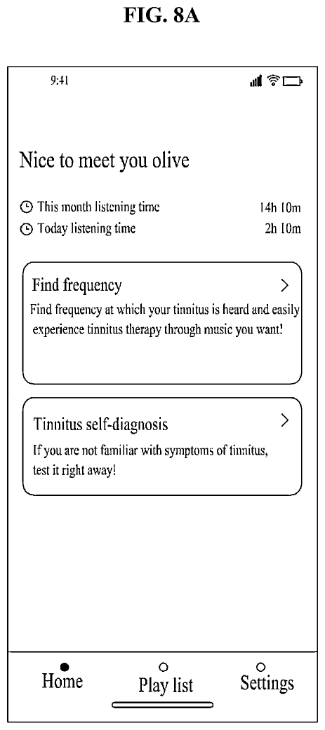

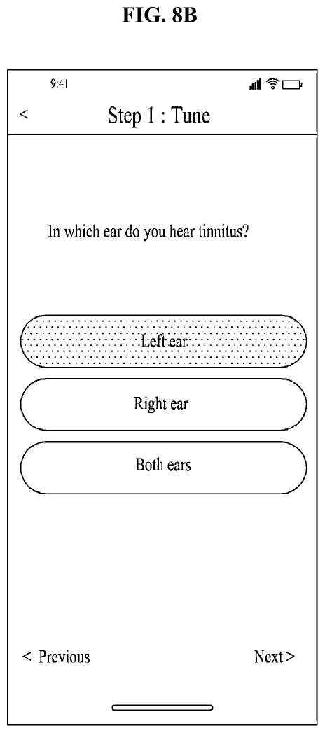

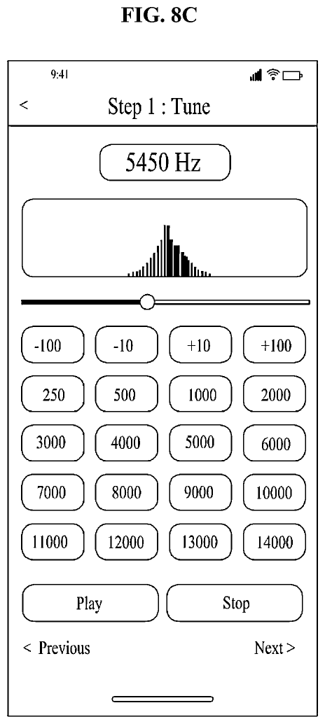

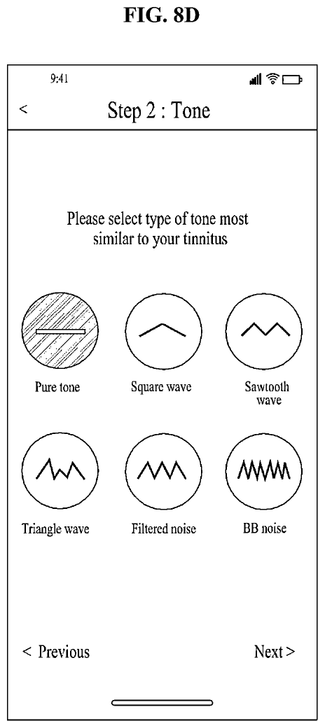

FIGS. 8A to 8D are diagrams illustrating an example of a tinnitus test according to an embodiment.

Referring to FIG. 8A, a tinnitus digital therapy apparatus involving cognitive behavior therapy and tinnitus retraining therapy according to an embodiment may perform a tinnitus test for a tinnitus frequency and self-diagnosis through an application.

Referring to FIG. 8B, the tinnitus digital therapy apparatus involving cognitive behavior therapy and tinnitus retraining therapy according to an embodiment may ask a user from which ear tinnitus is heard through an application and receive a response from the user.

Referring to FIG. 8C, the tinnitus digital therapy apparatus involving cognitive behavior therapy and tinnitus retraining therapy according to an embodiment may provide sound sources of various frequencies and induce the user to select a tinnitus frequency with a frequency most similar to his or her own tinnitus.

Referring to FIG. 8D, the tinnitus digital therapy apparatus involving cognitive behavior therapy and tinnitus retraining therapy according to an embodiment may provide various tones and induce the user to select a tinnitus with a tone most similar to that of his or her own tinnitus. In addition, the tinnitus digital therapy apparatus involving cognitive behavior therapy and tinnitus retraining therapy according to an embodiment may induce the user to select a tinnitus with a volume most similar to that of his or her own tinnitus.

Thereafter, the tinnitus digital therapy apparatus involving cognitive behavior therapy and tinnitus retraining therapy according to an embodiment may provide a therapeutic sound source according to a tinnitus frequency and tone measured through an application.

As described above, the tinnitus digital therapy apparatus may classify a patient through an interview and appropriate test, and select an appropriate treatment method accordingly.

In stage 1, that is, when tinnitus is not severe, good effects may be obtained only by establishing appropriate environment.

In stage 2, that is, when tinnitus interferes with life to some extent but there is no auditory abnormality, improvement may be achieved by using a sound generator in the same way as in stage 1.

In stage 3, that is, when hearing loss is accompanied in stage 2, improvement may be achieved with a combination of a sound generator for a sound of nature and a sound generator for an environmental sound, using a hearing aid, or the like.

The tinnitus digital therapy apparatus involving cognitive behavior therapy and tinnitus retraining therapy according to an embodiment may determine tinnitus with software and improve the tinnitus by tinnitus retraining therapy and cognitive behavior therapy suitable for the tinnitus.

The apparatus described herein may be implemented with hardware components and software components and/or a combination of the hardware components and the software components. For example, the apparatus and components described in the embodiments may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of executing and responding to instructions. The processing device may run an operating system (OS) and one or more software applications that run on the OS. The processing device also may access, store, manipulate, process, and create data in response to execution of the software. For convenience of understanding, one processing device is described as being used, but those skilled in the art will appreciate that the processing device includes a plurality of processing elements and/or multiple types of processing elements. For example, the processing device may include multiple processors or a single processor and a single controller. In addition, different processing configurations are possible, such a parallel processors.

The software may include a computer program, a piece of code, an instruction, or some combination thereof, for independently or collectively instructing or configuring the processing device to operate as desired. Software and/or data may be embodied in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described methods may be embodied in the form of program instructions that can be executed by various computer means and recorded on a computer-readable medium. The computer readable medium may include program instructions, data files, data structures, and the like, alone or in combination. Program instructions recorded on the media may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like.

Although the embodiments have been described by the limited embodiments and the drawings as described above, various modifications and variations are possible to those skilled in the art from the above description. For example, the described techniques may be performed in a different order than the described method, and/or components of the described systems, structures, devices, circuits, etc. may be combined or combined in a different form than the described method, or other components, or even when replaced or substituted by equivalents, an appropriate result can be achieved.

Therefore, other implementations, other embodiments, and equivalents to the claims are within the scope of the following claims.

According to embodiments, it is possible to provide a tinnitus digital therapy apparatus and method with Cognitive Behavior Therapy (CBT) and Tinnitus Retraining Therapy (TRT), which can alleviate tinnitus and improve tinnitus awareness by changing the user's perception for tinnitus by using two of cognitive behavior therapy (CBT) and tinnitus retraining therapy (TRT) in combination.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A tinnitus digital therapy method involving cognitive behavior therapy and tinnitus retraining therapy, which is performed by a computer device, the method comprising:
performing tinnitus retraining therapy (TRT) corresponding to a tinnitus frequency of a user;
performing cognitive behavior therapy (CBT) such that the user is to recognize tinnitus to change from a negative reaction to a positive reaction.

2. The tinnitus digital therapy method of claim 1, wherein the performing of the tinnitus retraining therapy (TRT) further includes
identifying the user's preference for a positive sound stimulus through a question provided by an application installed in a terminal and an answer; and
checking the tinnitus frequency of the user and a volume through the question provided by the application and the answer.

3. The tinnitus digital therapy method of claim 2, wherein the checking of the tinnitus frequency of the user and the volume includes determining the tinnitus frequency through a tinnitus test through the question provided by the application installed in the terminal and the answer, and identifying a frequency and an intensity of a tone or noise closest to the tinnitus that the user feels most uncomfortable through the tinnitus test to perform matching of a closest frequency and a closest volume.

4. The tinnitus digital therapy method of claim 2, wherein the checking of the tinnitus frequency of the user and the volume includes performing a test while changing the volume of a stimulus sound using a pure tone or noise to find out the volume of the tinnitus, and checking the volume of the tinnitus by adjusting the stimulus sound while determining whether the tinnitus is larger or smaller than a matched test sound, when the tinnitus frequency is identified.

5. The tinnitus digital therapy method of claim 1, wherein the performing of the tinnitus retraining therapy (TRT) further includes:
modulating a sound source for tinnitus treatment according to the tinnitus frequency of the user; and
positively restructuring a situation or event in which the tinnitus occurs.

6. The tinnitus digital therapy method of claim 5,
wherein the modulating of the sound source includes identifying the tinnitus frequency of the user and applying a filter to perform the tinnitus treatment using notch therapy that removes a predetermined band included in the tinnitus frequency.

7. The tinnitus digital therapy method of claim 1, wherein the performing of the tinnitus retraining therapy (TRT) further includes:
performing training to identify an automatic thought for the tinnitus;
planning and evaluating the automatic thought for the tinnitus; and
performing training to record the automatic thought for the tinnitus to identify preference for positive sound stimuli by planning and evaluating the automatic thought for the tinnitus.

8. The tinnitus digital therapy method of claim 1, wherein the performing of the cognitive behavior therapy (CBT) further includes:
reinforcing behavioral beliefs for the tinnitus;
practicing behavior repetition for the tinnitus; and
evaluating an emotional reaction for the tinnitus to perform training to identify an automatic thought for the tinnitus through evaluation of the emotional reaction.

9. A tinnitus digital therapy apparatus involving cognitive behavior therapy and tinnitus retraining therapy, the apparatus comprising:
a tinnitus retraining therapy unit configured to perform tinnitus retraining therapy (TRT) corresponding to a tinnitus frequency of a user; and
a cognitive behavior therapy unit configured to perform cognitive behavior therapy (CBT) such that the user is to recognize tinnitus to change from a negative reaction to a positive reaction.

10. The tinnitus digital therapy apparatus of claim 9, wherein the tinnitus retraining therapy unit includes:
a sound stimulation preference identification unit configured to identify the user's preference for a positive sound stimulus through a question provided by an application installed in a terminal and an answer; and
a tinnitus frequency and volume checking unit configured to check the tinnitus frequency of the user and a volume through the question provided by the application and the answer.

11. The tinnitus digital therapy apparatus of claim 10, wherein the tinnitus frequency and volume checking unit is configured to determine the tinnitus frequency through a tinnitus test through the question provided by the application installed in the terminal and the answer, and identify a frequency and an intensity of a tone or noise closest to the tinnitus that the user feels most uncomfortable through the tinnitus test to perform matching of a closest frequency and a closest volume.

12. The tinnitus digital therapy apparatus of claim 10, wherein the tinnitus frequency and volume checking unit is configured to perform a test while changing the volume of a stimulus sound using a pure tone or noise to find out the volume of the tinnitus, and check the volume of the tinnitus by adjusting the stimulus sound while determining whether the tinnitus is larger or smaller than a matched test sound, when the tinnitus frequency is identified.

13. The tinnitus digital therapy apparatus of claim 9, wherein the tinnitus retraining therapy unit includes:
a sound source modulator configured to modulate a sound source for tinnitus treatment according to the tinnitus frequency of the user; and
a positive restructuring unit configured to positively restructure a situation or event in which the tinnitus occurs.

14. The tinnitus digital therapy apparatus of claim 9, wherein the tinnitus retraining therapy unit includes:
an automatic thought identification unit configured to perform training to identify an automatic thought for the tinnitus;
an automatic thought evaluation unit configured to plan and evaluate the automatic thought for the tinnitus; and
an automatic thought record training unit configured to perform training to record the automatic thought for the tinnitus.
wherein the tinnitus retraining therapy unit is configured to identify preference for positive sound stimuli by planning and evaluating the automatic thought for the tinnitus.

15. The tinnitus digital therapy apparatus of claim 9, wherein the cognitive behavior therapy unit includes:
a behavioral belief reinforcement unit configured to reinforce behavioral beliefs for the tinnitus;
a behavior repetition practice unit configured to practice behavior repetition for the tinnitus; and
an emotional reaction evaluation unit configured to evaluate an emotional reaction for the tinnitus,
wherein the cognitive behavior therapy unit is configured to perform training to identify an automatic thought for tinnitus through evaluation of the emotional reaction.
